(19) United States
(12) Patent Application Publication
(10) Pub. No.: US 2025/0237481 A1
(43) Pub. Date: Jul. 24, 2025

(54) ENHANCED TRAINING SYSTEM FOR LAW ENFORCEMENT, SECURITY, AND MILITARY PERSONNEL

(71) Applicant: A.U.FIRE, Carson, CA (US)

(72) Inventor: Timothy Andrew Pearce, Carson, CA (US)

(21) Appl. No.: 18/421,041

(22) Filed: Jan. 24, 2024

(51) Int. Cl. F41G 3/26; G09B 19/00

(52) U.S. Cl. CPC F41G 3/26; G09B 19/00

(57) ABSTRACT

A training apparatus is provided, including at least one wireless receiver assembly, at least one controller wirelessly communicating with the wireless receiver assembly manipulable by a trainer to send activation signals to the wireless receiver assembly, and an integrated covering comprising a plurality of raised conductive fabric patches therein, the integrated covering configured to fit on an individual such that at least a portion of the plurality of raised conductive fabric patches contacts the individual. The wireless receiver assembly is responsive to the activation signals to cause activation of one or more of the plurality of raised conductive fabric patches, thereby causing contraction of at least one muscle of the individual.

### BACKGROUND

### I. Field

The present invention relates generally to personal under fire trainers for law enforcement, security, and military personnel.

### II. Description of the Related Art

Police officers in training undergo many drills, one of which is practicing to cope during a simulated gun fight wherein the officer is disabled during the fight. Such drills are sometimes referred to as “Officer Down” scenarios. In such a training scenario a trainee might be positioned in a practice range or combat shooting course in which various targets move and simulated weapon shots are directed to the trainee. The purpose is to train an officer to return fire or otherwise cope with high stress circumstances during a gunfight.

As understood herein, a trainee simulating being hit by gunfire during an “Officer Down” exercise has typically required the trainee to pretend that his primary gun hand is rendered useless, tucking his primary gun hand in his belt and finishing the combat shooting course with his off-hand. Simply returning fire during a drill using the off-hand is less than a realistic modeling of actual gun fight conditions, in which an officer might experience pain and trauma far beyond the inconvenience of tucking a hand in a belt.

One improvement to such trainee simulation is presented in U.S. Pat. No. 8,308,482. The '482 patent provides a system that causes a quick, powerful, yet safe muscle contraction to the trainee that temporarily immobilizes a portion of the trainee's body. The challenge with a system such as that shown in the '482 patent is the construction of the elements contacting the trainee's body. Difficulty in employing the '482 components in high stress simulation conditions can be an issue, and ease in use during training, minimization of the need for bulky components and or cables, and reducing any hygienic issues, such as cleaning of the components, would be beneficial.

It would therefore be useful to offer a training system that overcomes issues with prior designs.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Thus according to one embodiment, there is provided a training apparatus comprising at least one wireless receiver assembly, at least one controller wirelessly communicating with the wireless receiver assembly manipulable by a trainer to send activation signals to the wireless receiver assembly, and an integrated covering comprising a plurality of raised conductive fabric patches therein, the integrated covering configured to fit on an individual such that at least a portion of the plurality of raised conductive fabric patches contacts the individual. The wireless receiver assembly is responsive to the activation signals to cause activation of one or more of the plurality of raised conductive fabric patches, thereby causing contraction of at least one muscle of the individual.

According to another embodiment, there is provided a training apparatus comprising an integrated covering comprising a plurality of raised conductive fabric patches therein, the integrated covering configured to fit on an individual such that at least a portion of the plurality of raised conductive fabric patches contacts the individual, an internal connector provided with the integrated covering, and a plurality of wires positioned within the integrated covering connecting the internal connector with the plurality of raised conductive fabric patches.

According to a further embodiment, there is provided a method for simulating a gunshot wound comprising receiving, at a controller, trainer input of an activate command, responsive to the trainer input, wirelessly sending an activate signal to a wireless receiver, and responsive to receiving the activate signal, causing the receiver to energize at least one raised conductive fabric patch provided within an integrated covering, the at least one raised conductive fabric patch contacting a trainee's skin above a muscle to cause the muscle to contract.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 illustrates a prior art system used for gunshot simulation training;

FIG. 2 shows an arm-wearable sleeve or covering in accordance with the present design;

FIG. 3 is a view of the inside of one embodiment of the sleeve or covering in accordance with the present design;

FIG. 4 illustrates a vest wearable by a trainee and including a central control unit;

FIG. 5 is a general representation of the present environment with a scenario including three trainees and one trainee receiving an electrical charge in accordance with the present design;

FIG. 6 is a representation of one embodiment of the electrical components of a central control unit;

FIG. 7 shows a training unit according to the present design; and

FIG. 8 illustrates a central control unit.

### DETAILED DESCRIPTION

In this document, the words “embodiment,” “variant,” and similar expressions are used to refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

An assembly is provided that can be worn by a trainee and operated remotely by a trainer to deliver a quick, powerful, yet safe muscle contraction to the trainee that temporarily immobilizes a portion of the trainee's body, similar to a gunshot wound. The gunshot simulator can be used to train public safety officers, military personnel, recreational participants in paintball contests, and the like to maintain accuracy and focus in combat shooting situations after being hit with an immobilizing simulated gunshot. The trainer can remotely target and contract any of the trainee's biceps, forearms, hamstrings, calves, abdominal muscles, or other muscles or muscle groups, including but not limited to quadriceps, triceps, and/or back muscles, to temporarily and safely incapacitate the targeted body section using muscle contraction.

Previous systems have called for attaching electrodes to the trainee. The present training apparatus includes body attachable sleeve type members that can be taken on and off of arms and legs, for example, and surround the limb or body part. Such body attachable members may further include torso attachable devices, such as devices affixable about the waist of the trainee. Each body attachable member includes electrical components and connectors facilitating carrying out a gunshot wound training exercise while being highly resistant to wire fouling, electrode attachment and detachment issues, wire pulling, sudden quick movements, and other constant connectivity issues.

The flexible, body attachable devices disclosed herein are in one embodiment primarily constructed of a flexible material or materials generally, such as neoprene or another stretchable material. Electrical type debilitating charges may be provided via a raised fabric interface or patch configured to provide a direct interface with skin and deliver a charge to the skin of the arms, legs, torso, or other relevant parts of the body of the trainee.

Electrical power is provided to the flexible, body attachable device and the device may include a wireless or Bluetooth or other communication receiver assembly, or one may be provided to a unit attached to a vest that electrically connects to the flexible body attachable member or members. A hand-held controller, potentially including a smartphone or other wireless or wired device, communicates with the receiver assembly and can be operated by a trainer to send activation signals to the receiver assembly. The receiver assembly, responsive to the activation signals, causes a power source to activate one or more of the electrodes and thereby causes contraction of at least one muscle of the trainee, the one muscle located beneath the skin of the trainee proximate the raised conductive fabric. The application of energy in this manner provides an electrical charge causing muscle immobilization thereby simulating a gunshot wound at the site of the raised conductive fabric patch.

In some implementations, the wireless receiver assembly communicates with the electrodes through wires connected to the individual raised conductive fabric patches. The wires are stretchable and are located on the inner surface of the flexible, body attachable device in one embodiment. The wireless receiver assembly may wirelessly activate the raised conductive fabric patch.

The system may receive, at a controller, trainer input of an activate command, and responsive to the trainer input, wirelessly send an activate signal to the wireless receiver associated with a desired trainee. Responsive to receiving the activate signal, the system causes the wireless receiver to energize at least one raised conductive fabric patch inside the flexible, body attachable device, the at least one raised conductive fabric patch contacting a trainee's skin above a muscle, causing the muscle to contract. An emergency stop signal may be provided by the trainee, in one embodiment using an electrical switch configured to deenergize the electricity provided via the raised conductive fabric patch or patches. In another embodiment, certain criteria being encountered by the unit provided with each trainee may cause the electrical charge to be shut off.

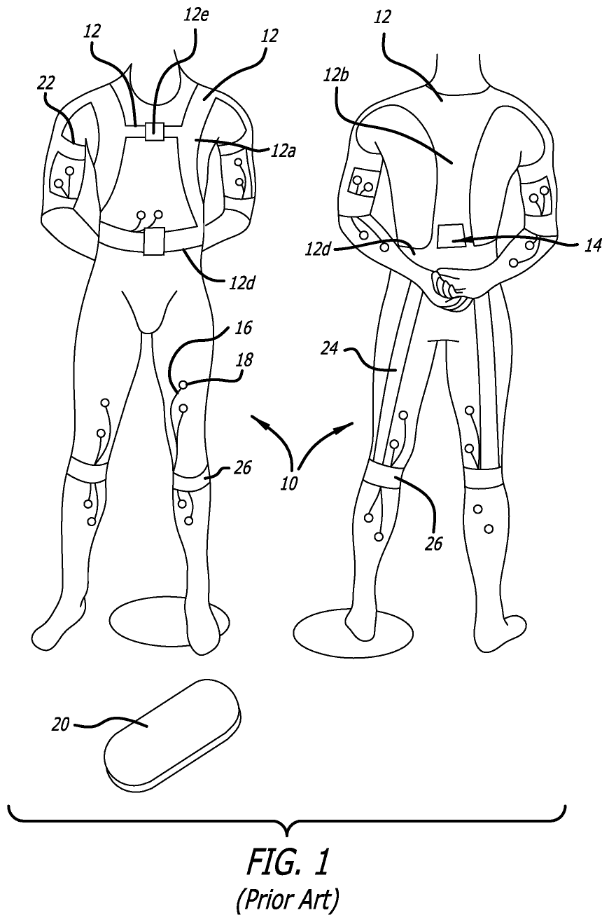

FIG. 1 illustrates a prior under fire training system designated 10. The prior under fire training system 10 includes a trainee-wearable harness 12 that bears a portable battery-powered receiver assembly 14. A harness 12, which can be made of nylon webbing, may be worn over a trainee's clothing and supports leads 16 which connect the receiver assembly 14 with plural electrical muscle stimulation (EMS) electrodes 18 which are selectively activated by the receiver assembly 14 responsive to trainer stimulation command signals received wirelessly from a transmitter remote control (RC) 20.

The harness 14 of the prior art system may be worn by a trainee and was triggered remotely by a trainer manipulating the RC 20. When activated, the electrodes 18 produced a strong muscle contraction on a targeted area on the trainee's body (e.g., arms, legs or abdomen). The resulting muscle contraction caused an extreme distraction, discomfort and immobilization of the targeted limb, thus simulating a life-like incapacitating injury, such as a gunshot wound. In this way, the trainee completes various training scenarios while training himself to re-gain focus in the midst of a significant physical distraction so that he/she may return fire at a simulated advancing shooting suspect with accuracy despite the surprise, stress, and immobilization of the simulated gunshot wound.

The prior art harness 12 enveloped at least portions of the trainee's torso, shoulders, and upper legs. The prior system had employed shoulder straps 22a merging into a back center strip 12b, with the receiver assembly 14 being sewn into or otherwise supported by the center strip 12b, chest strap 12c and waist strap 12d, and detachable clips 12e. Further required were ring-shaped upper and lower elastic armbands 22 having leads 16 connected to electrodes 18 as well as left and right leg strips 24 and leg bands 26.

This array of components shown in FIG. 1 are generally exposed and as a result can be awkward and cumbersome in a weapons training situation. In extremely stressful conditions trainees may pull connections or be caught up with wiring or have issues performing the training tasks. Quick movements by the trainee could cause electrodes to be dislodged, for example, and electrodes may lose connection due to perspiration or excessive activity. As a result, while the harness has been a generally workable and beneficial solution, the present design seeks to improve overall functionality of the system when the trainee encounters stressful conditions.

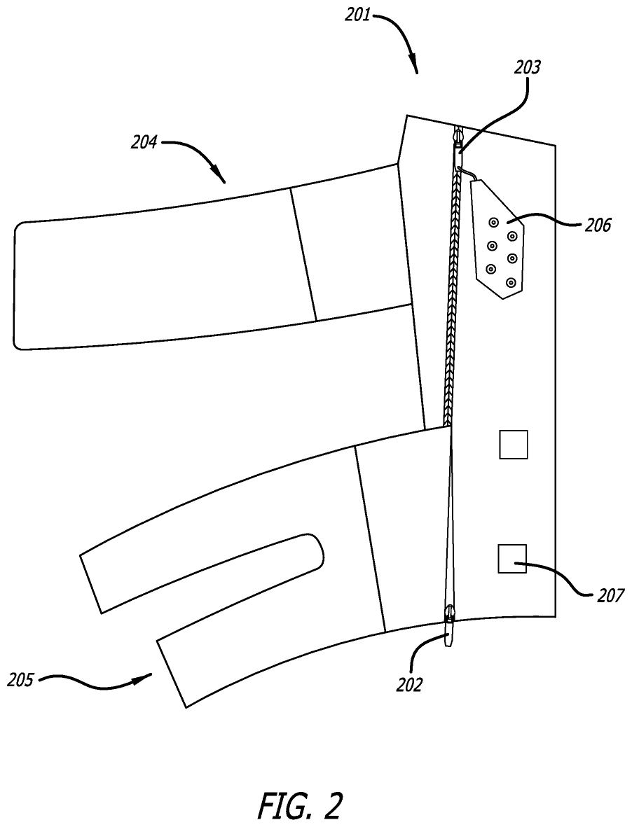

FIG. 2 illustrates an arm component 201 of the system in accordance with the present design. Arm component 201 is attachable to an arm of the user and includes zippers 202 and 203 that may be opened for the trainee to insert his or her arm and connections 204 and 205 that may be wrapped around the arm and may be secured by, for example, Velcro. Any securing components may be employed to provide protection for the respective zipper, and other openable members may be employed, such as hemmed slits in place of zippers. As shown in FIG. 2, also provided is a connector 206, which may be a quick release ring connector that allows for communication and application of electrical power, such as electrical current, to a series of raised conductive fabric patches disposed inside arm component 201. Connector 206 may have any number of connections including six connections in one embodiment. Graphical representations may be provided on arm component 201, including directional information directing the trainee to the top and bottom of the arm component, points where the trainee may be hit, sizing, and so forth. Markers such as marker 207 may provide locations of the raised conductive fabric pads for positioning when being fitted to the trainee. As may be appreciated, such a flexible design may be worn by trainees of varying sizes. Connections 204 and 205 serve as compression wraps that facilitate providing the raised conductive fabric pads against or in direct contact with the skin of the trainee.

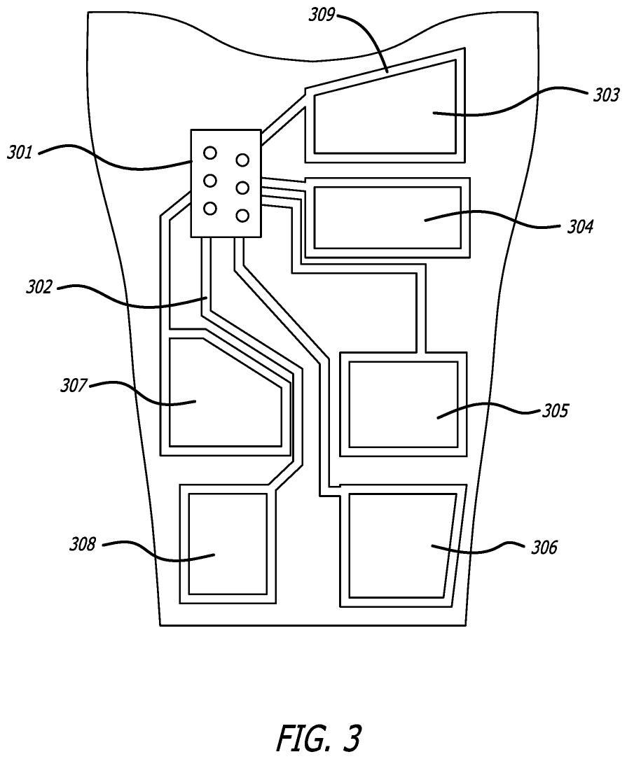

FIG. 3 illustrates the inside of arm component 201 if the arm component 201 was cut open at the seam between zippers 202 and 203. FIG. 3 illustrates the inside 301 of connector 206 connected by covered wires such as wire 302 to each of the six raised conductive fabric patches 303 to 308 provided. In general, raised conductive fabric patches are provided in pairs, one positive and one negative raised conductive fabric patch, but at least one such raised conductive fabric patch is employed to provide the requisite electrical charge. In one embodiment, connector 206 has six connections that fit into six receptacles provided in arm component 202, each receptacle electrically connected to a raised fabric patch such as raised conductive fabric patch 303. Engaging one or more of the raised conductive fabric patches when properly positioned causes muscle contraction and/or immobilization. Such raised conductive fabric patches may be EMS (electrical muscle stimulation) fabric patches or any electrical component that can adequately provide the required electrical charge to the trainee. Spacer mesh, not shown in this view, is provided below each of the conductive fabric patches 303-308 to lift the conductive fabric patch to the skin of the trainee, forming a positive connection with the skin of the trainee. In one embodiment, the raised conductive fabric patches are provided on the arm component by bonding with tape, such as tape 309, using a heat press.

More or fewer than six conductive fabric patches may be employed, and other configurations where the conductive fabric patches are positioned proximate the trainee's skin may be employed. Wires such as wire 302 provided in each arm component or leg component may be stretchable. The result is a wearable, stretchable, washable interface that can be used effectively with trainees in the scenarios contemplated without the risk of pulling electrodes from the trainee, the trainee fouling wires, or some other event removing or impeding the electrical path to the trainee.

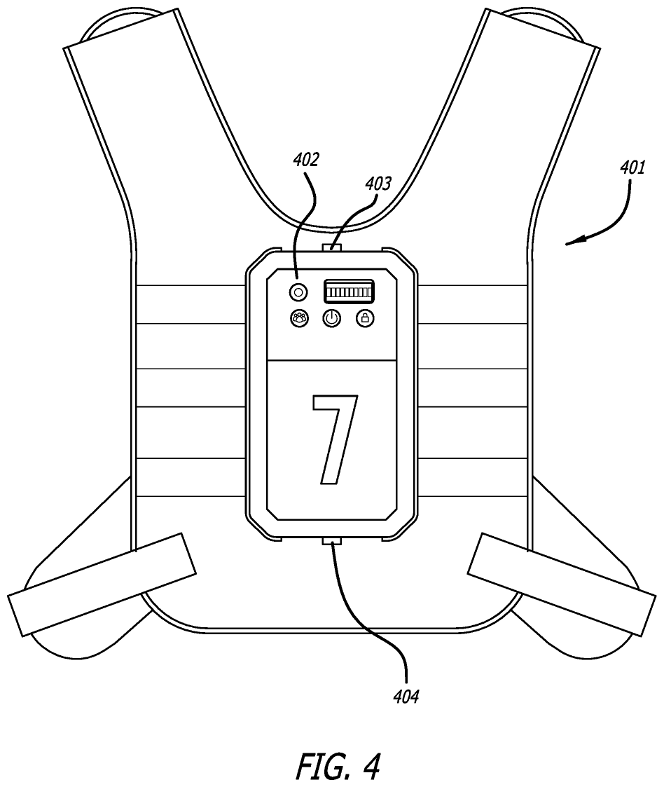

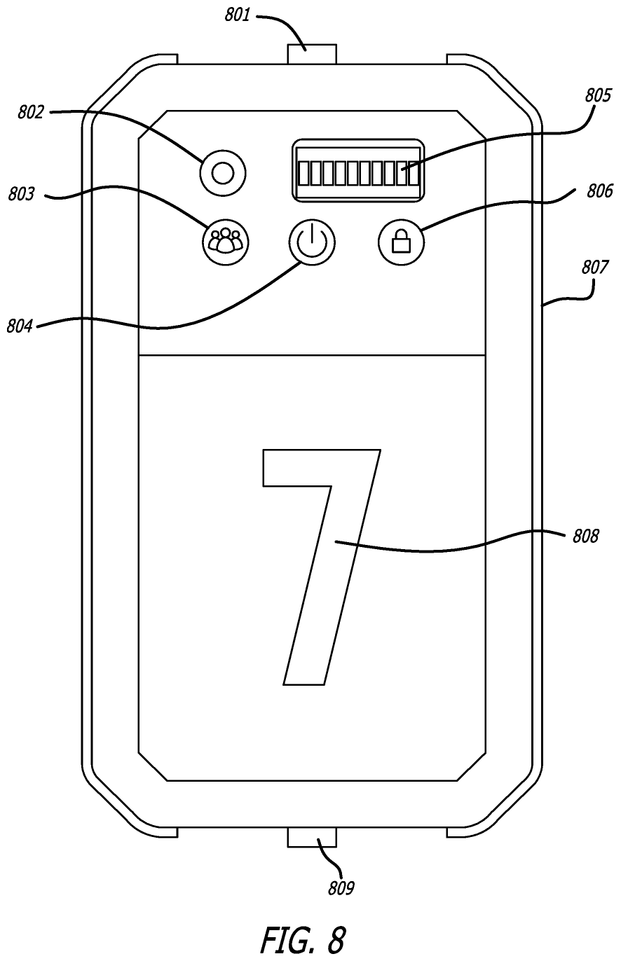

Other components may be provided in the system. FIG. 4 illustrates an embodiment including a general vest type component 401 that similarly may include electrodes or raised conductive fabric patches on the inside front thereof, such as over the abdomen, that cause an electrical charge simulating an incapacitating injury such as a gunshot to the torso or abdomen of the trainee. The electrodes or raised conductive fabric patches may be provided on a cummerbund type device or a full jersey with abdominal patches or electrodes provided therein. In the present embodiment, a central control unit 402 is provided that may receive signals from a remote controller and may effectuate the signals to deliver a debilitating charge to the trainee. Connectors 403 and 404 in this embodiment provide connections from central control unit 402 to system items worn by the trainee, such as arm component 201. Central control unit 402 has an on/off switch, power indicator, and may include other functions and is shown in more detail in FIG. 8. In operation, multiple such devices may be employed on multiple trainees. Each central control unit is assigned an identifier and a control person such as a training instructor may provide a simulated event for a particular trainee and issue an electrical charge to that trainee only. In the embodiment shown, top electrical port 405 may provide signals to arm components while bottom electrical port 406 provides signals to leg components.

A vest as shown in FIG. 4 is not required to be worn or used with the system. Vest type component 401 provides a means for or way to maintain central control unit 402. In the embodiment of FIG. 4, central control unit 402 may be secured to vest type component 402 using a Molle fork attachable to any Molle system. In other embodiments, central control unit 402 can be provided in pouches and can be worn in any manner wherein central control unit 402 can be provided with the body of the wearer.

Leg components, i.e., flexible, body attachable sleeves attachable to the leg or legs of the trainee, may be provided in a form generally similar in concept to the arm components of FIGS. 2 and 3 but are not illustrated herein. Leg components may cover only the calves or alternately or only the thighs, and/or may cover both areas. Similar to the arm component 201, internal raised fabric conductive patches may be provided and connected via stretchable wire, affixed by bonding with tape and a heat press, to a connector having similar functionality to connector 206. The connector provides electrical and control connection between the central control unit 402 and the leg component or components.

The system may include stretchable coiled cables between receiver or central control unit 402 to arm component 201. The fabric wires inside arm component 201 may also be stretchable. These components are stretchable, in one embodiment made of the same conductive fabric as the raised conductive fabric patches. In one construction the wires are laser cut into long thin lines and act as wires. Such wires may be bonded onto arm component 201 and insulated with stretchable rubber tape as part of the bonding.

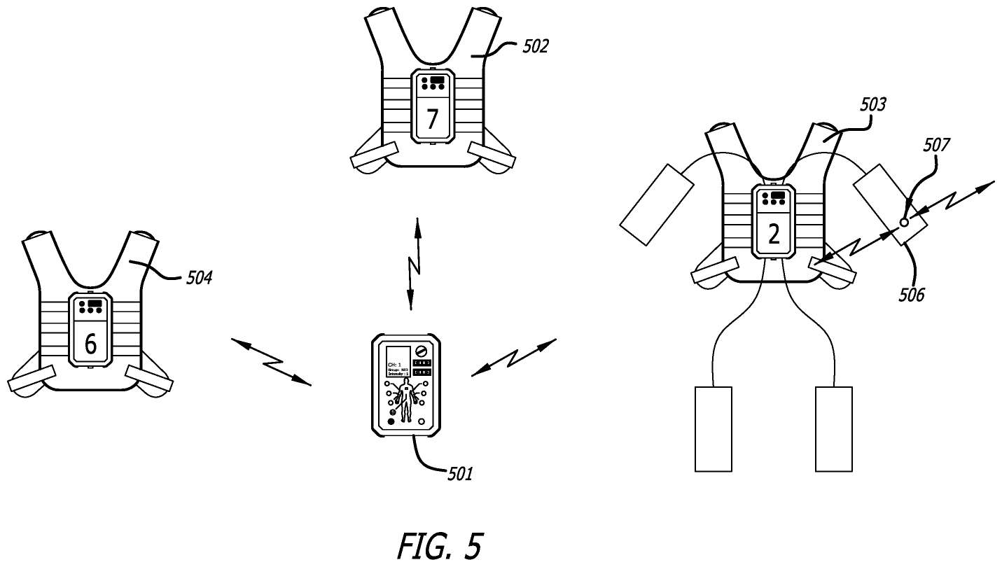

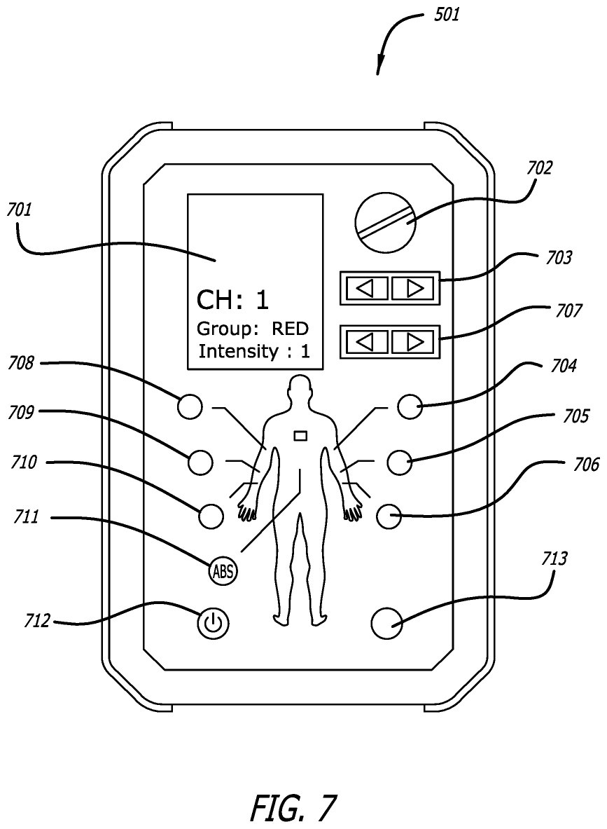

FIG. 5 is a representation of the system and relevant components in operation. From FIG. 5, FIG. 5, training unit 501 provides for selection of different trainee equipment, shown as four trainees each wearing vests 502, 503, and 504. FIG. 7 illustrates a device that may be used as training unit 501. The trainer can, at an appropriate time, indicate trainee 2 wearing vest 503 is to receive an electrical charge representing a bullet striking her right forearm. This indication is provided from training unit 501 to central control unit 505 on vest 503 worn by trainee 2, which in turn sends a signal and electrical charge to right arm component 506 which applies the electrical charge at point 507, debilitating the trainee as appearing to have been shot in the lower right arm.

Multiple muscles or sections of limbs or multiple limbs can be triggered or contracted at the same time. The instructor may press multiple buttons at the same time and all muscle groups corresponding to those buttons will be contracted, such as stimulating and contracting the inner-forearm and the bicep at the same time. Alternately, the instructor may contract the trainee's bicep and incapacitate that section of the trainee's arm and the trainee can still manipulate her hand and forearm muscles voluntarily.

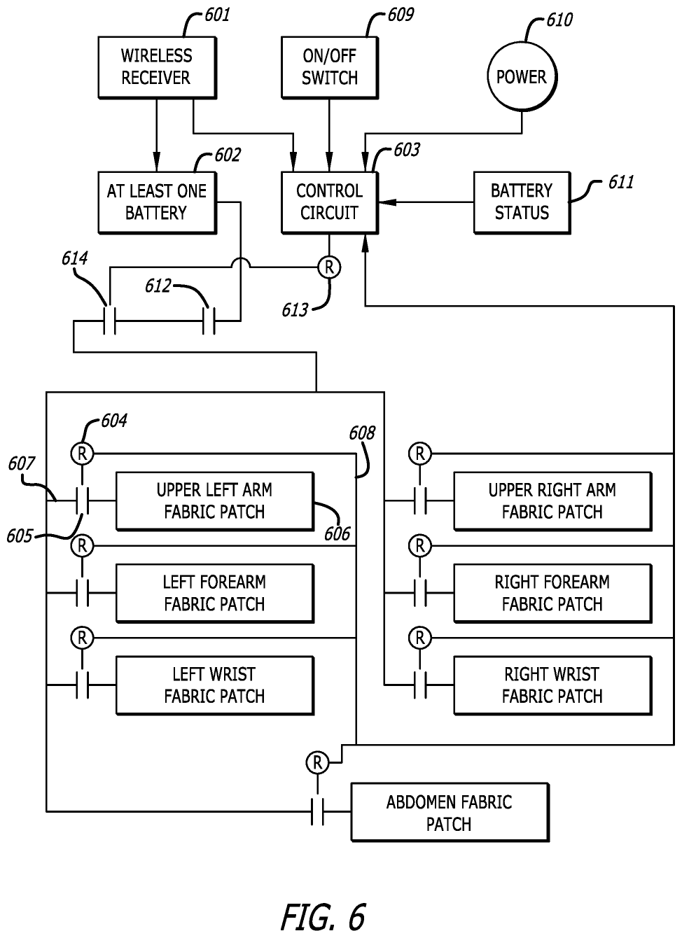

FIG. 6 is a simplified circuit diagram of an example central control unit such as central control unit 505 with electrical connections to the various components connected to a vest such as vest 503. Central control unit 505 can include a wireless receiver 601 powered by one or more batteries 602. Control circuit 603 may be implemented by a processor such as but not limited to a programmable gate array or microprocessor and may be powered by the one or more batteries 602. The wireless receiver 601 may take any form but may be configured to receive a pulse controlled modulation (PCM) signal from the training unit 501.

The system may initiate a pulsating current in one embodiment or may automatically and/or rapidly switch back and forth between two muscle groups, such as forearm and bicep, creating a convulsing effect of the area. Such convulsing not only incapacitates the trainee but is also extremely distracting for the trainee, increasing the overall difficulty required to deal with a convulsing limb. In operation, different raised fabric patches may be electrified to produce this effect, which is programmed and commanded by the central control unit 505 in combination with the central control unit 402.

In response to signals received by wireless receiver 601, control circuit 603 may selectively energizes one or a group of relays including relay 604, with each relay 604 closing, when actuated, a respective contact 605. In turn, each contact 605 when closed completes an electrical path between the one or more batteries 602 and a respective fabric patch such as fabric patch 606. In FIG. 6, individual raised conductive fabric patch may be energized for, respectively, contracting the trainee's upper left arm, left forearm, left wrist, upper right arm, right forearm, right wrist, and abdomen. The one or more batteries 602 communicates main power to the raised fabric patches such as raised fabric patch 606 through lines 607. Control circuit 603 communicates control signals to relays such as relay 604 through respective control lines 608, with each wire such as wire 302 having a main line 607 and a control line 608 in some embodiments. While FIG. 6 shows that each contact, such as contact 605, closes to energize a single raised conductive fabric patch, each contact 605 may energize multiple raised conductive fabric patches. Also, while FIG. 6 shows a variety of raised conductive fabric patches, more or fewer than those shown may be provided.

Control circuit 603 may energize and deenergize central control unit 505 in response to on and off signals from a manually operated switch 609. Also, control circuit 603 may provide indication of power and battery state by appropriately illuminating power and battery lamps 610, 611, e.g., by illuminating the power lamp 610 when power is supplied to wireless receiver 601 and by lighting the battery lamp 611 when battery voltage falls below a threshold or alternately providing graduated power levels, such as full, ¾ full, ½ full, ¼ full, and empty.

In some embodiments, the trainee may be given the option of terminating electrode energization regardless of signals being received by wireless receiver 601 as a safety precaution. A trainee kill switch may be provided which, when actuated, opens a contact 612 between the at least one battery 602 and raised fabric patches such as raised fabric patch 606.

Also, in the event that central control unit 505 loses communication with training unit 501 or a malfunction occurs, a timeout kill switch may be provided. If central control unit 505 does not receive information from the training unit 501 for longer than a predetermined timeout period (and/or in the event that the central control unit 505 receives unexpected signals indicating transmitter malfunction), the control circuit 603 controls a relay 613 to open a contact 614 between the at least one battery 602 and fabric patches such as raised fabric patch 606. Opening either contact 612, 614 may result in only the fabric patches, such as raised fabric patch 606, being held deenergized.

An alternative embodiment employs transformers to increase voltage rather than the contacts illustrated in FIG. 6. The system may additionally provide battery monitoring that polls the battery and updates the status of the battery. The battery charger may employ a rechargeable pack.

FIG. 7 is a representation of one embodiment of training unit 501. Power switch 712 may be used to power on and off training unit 501. Screen 701 is provided in this embodiment and displays a communication channel corresponding to the channel associated with and configured to be received a central control unit on a specific vest associated with one trainee. Trainees may be split into multiple groups, such as a “RED” group and a “BLUE” group, where the RED group is selected in this representation, specifically channel 1 of the RED group. Selector 702 allows the user to select a desired transmission channel. Toward the bottom of the training unit 501 is a human form and the various areas on the trainee's body where the trainee can receive electrical charge. The user may press one of the buttons available. In this particular embodiment, right bicep button 704, right inner forearm 705, right outer forearm 706, left bicep 708, left inner forearm 709, left outer forearm 710, and abdominal muscles 711 are selectable by the user or trainer. While eight selectable regions are shown in this representation (three to each arm, two to the abdomen (one on each side of the abdomen)), leg sleeves may be provided to upper and/or lower legs of the trainee in forms similar to those discussed for the arms, with connections provided to the bottom of central control unit 505. More or fewer zones or regions of application of energy may be provided. Two arrow switches such as arrow switch 703 are provided, allowing channel and group selection, i.e., the individual trainee to receive electrical charge. Selector buttons 707 are intensity selectors and the user or instructor may select intensity levels in any range, such as one through four or one through ten. Button lock 713 allows for locking a particular button, such as buttons 704 to 711, where one of the buttons 704-11 may be selected and applied continuously after button 713 has been selected.

FIG. 8 is a representation of central control unit 505 including top Y-cable connection port 801. The connection may branch to the right and left arm sleeves. Power indicator 802 indicates when power is on to central control unit 505, while channel assign button 803 assigns the transmission and receive channel of the unit, allowing the training unit to communicate with central control unit 505. Pressing channel assign button 803 performs pairing of the devices. Power switch 804 turns the unit on, while battery charge indicator 805 shows charge of the battery. Button lock 806 locks the buttons such as channel assignment button 803 to avoid button pressing in undesirable conditions, i.e., when the trainee places her back against a wall during an exercise. In this embodiment, a shock absorbing bumper 807 is provided, and a large LED channel number 808 is provided. Port 809 is the abdominal and leg connection port, operating in a manner similar to Y-cable connection port 801. Multiple connections may be provided via these ports.

While the present design has been described generally in terms of simulating a gunshot wound, the design may not only simulate gunshot wounds but electrical current may be applied that also simulates other injuries that can incapacitate the trainee, such as knife cuts, blunt force trauma, and or physical injuries such as torn muscles, tendons, and ligaments. Different electrical profiles can be provided to the sleeve disclosed herein that simulate these different injuries, such as a sharp, narrow electrical profile representing a knife wound.

Thus according to one embodiment, there is provided a training apparatus comprising at least one wireless receiver assembly, at least one controller wirelessly communicating with the wireless receiver assembly manipulable by a trainer to send activation signals to the wireless receiver assembly, and an integrated covering comprising a plurality of raised conductive fabric patches therein, the integrated covering configured to fit on an individual such that at least a portion of the plurality of raised conductive fabric patches contacts the individual. The wireless receiver assembly is responsive to the activation signals to cause activation of one or more of the plurality of raised conductive fabric patches, thereby causing contraction of at least one muscle of the individual.

According to another embodiment, there is provided a training apparatus comprising an integrated covering comprising a plurality of raised conductive fabric patches therein, the integrated covering configured to fit on an individual such that at least a portion of the plurality of raised conductive fabric patches contacts the individual, an internal connector provided with the integrated covering, and a plurality of wires positioned within the integrated covering connecting the internal connector with the plurality of raised conductive fabric patches.

According to a further embodiment, there is provided a method for simulating a gunshot wound comprising receiving, at a controller, trainer input of an activate command, responsive to the trainer input, wirelessly sending an activate signal to a wireless receiver, and responsive to receiving the activate signal, causing the receiver to energize at least one raised conductive fabric patch provided within an integrated covering, the at least one raised conductive fabric patch contacting a trainee's skin above a muscle to cause the muscle to contract.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A training apparatus comprising:
at least one wireless receiver assembly;
at least one controller wirelessly communicating with the wireless receiver assembly manipulable by a trainer to send activation signals to the wireless receiver assembly; and
an integrated covering comprising a plurality of raised conductive fabric patches therein, the integrated covering configured to fit on an individual such that at least a portion of the plurality of raised conductive fabric patches contacts the individual;
wherein the wireless receiver assembly is responsive to the activation signals to cause activation of one or more of the plurality of raised conductive fabric patches, thereby causing contraction of at least one muscle of the individual.

2. The training apparatus of claim 1, further comprising at least one switch operable to deactivate at least one raised conductive fabric patch responsive to a determination that the controller is deenergized or malfunctioning.

3. The training apparatus of claim 1, wherein the wireless receiver assembly communicates with the plurality of raised conductive fabric patches through respective wires connected to respective raised conductive fabric patches, the wires being supported within the integrated covering.

4. The training apparatus of claim 1, further comprising at least one switch actuatable by the individual to deactivate at least one raised conductive fabric patch in the presence of an activation signal from the controller.

5. The training apparatus of claim 1, wherein the integrated covering comprises a compression wrap configured to tighten the integrated covering about the individual.

6. The training apparatus of claim 3, wherein the wires are located inside the integrated covering and are covered by a barrier between the wires and the individual.

7. The training apparatus of claim 1, wherein the integrated covering comprises an internal connector connected to all of the plurality of raised conductive fabric patches.

8. A training apparatus comprising:
an integrated covering comprising a plurality of raised conductive fabric patches therein, the integrated covering configured to fit on an individual such that at least a portion of the plurality of raised conductive fabric patches contacts the individual;
an internal connector provided with the integrated covering; and
a plurality of wires positioned within the integrated covering connecting the internal connector with the plurality of raised conductive fabric patches.

9. The training apparatus of claim 8, wherein one or more of the plurality of raised conductive fabric patches is activated by activation signals received from a wireless receiver assembly, thereby causing contraction of at least one muscle of the individual.

10. The training apparatus of claim 9, wherein the wireless receiver assembly communicates with the plurality of raised conductive fabric patches through the plurality of wires.

11. The training apparatus of claim 8, wherein the integrated covering comprises a compression wrap configured to tighten the integrated covering about the individual.

12. The training apparatus of claim 8, wherein all of the plurality of wires are located inside the integrated covering and are covered by a barrier between the plurality of wires and the individual.

13. The training apparatus of claim 8, wherein the integrated covering comprises an internal connector electrically connected to all of the plurality of raised conductive fabric patches.

14. The training apparatus of claim 8, further comprising positional markings provided on an outside of the integrated covering.

15. Method for simulating a gunshot wound comprising:
receiving, at a controller, trainer input of an activate command;
responsive to the trainer input, wirelessly sending an activate signal to a wireless receiver;
responsive to receiving the activate signal, causing the receiver to energize at least one raised conductive fabric patch provided within an integrated covering, the at least one raised conductive fabric patch contacting a trainee's skin above a muscle to cause the muscle to contract.

16. The method of claim 15, further comprising responsive to receiving an emergency stop signal input by the trainee, deenergizing at least one raised conductive fabric patch in the presence of the activate signal.

17. The method of claim 15, further comprising automatically opening an electrical circuit between a source of raised conductive fabric patch energy and one raised conductive fabric patch to deactivate the raised conductive fabric patch responsive to a determination that the controller is deenergized.

18. The method of claim 15, wherein the integrated covering comprises a compression wrap configured to tighten the integrated covering about the trainee.

19. The method of claim 15, wherein the trainer input is received at a controller bearing plural buttons each corresponding to a respective raised conductive fabric patch proximate the trainee.

20. The method of claim 15, wherein the integrated covering comprises a portion of an arm or leg of the trainee.
